(19) United States
(12) Patent Application Publication
(10) Pub. No.: US 2004/0039115 A1
(43) Pub. Date: Feb. 26, 2004

(54) Polyethylene resin composition

(76) Inventor: Yukio Ishida, Chiba (JP)

Correspondence Address: BIRCH STEWART KOLASCH & BIRCH, PO BOX 747, FALLS CHURCH, VA, 22040-0747, US

(21) Appl. No.: 10/415,365

(22) PCT Filed: Sep. 4, 2002
(86) PCT No.: PCT/JP02/08982

(30) Foreign Application Priority Data
Sep. 6, 2001 (JP) 2001-270550

(51) Int. Cl. C08G 63/48

(52) U.S. Cl. 525/53; 525/240; 526/65; 526/352

(57) ABSTRACT

A polyethylene resin composition comprising 15 to 90% by weight of a polyethylene resin composition (A) and 85 to 10% by weight of a polyolefin resin composition (B), wherein the polyethylene resin composition (A) comprises ultra-high-molecular weight polyethylene (component (a-1)) having an intrinsic viscosity [η] of 10 to 40 dl/g and low-molecular weight to high-molecular weight polyethylene (component (a-2)) having an intrinsic viscosity [η] of 0.1 to 5 dl/g, the amount of said component (a-1) being more than 35% by weight and not more than 90% by weight, the amount of said component (a-2) being not less than 10% by weight and less than 65% by weight, each amount being based on the total amount of the component (a-1) and the component (a-2), and the polyethylene resin composition (A) has a density of 930 to 980 kg/m³ and an intrinsic viscosity [η] of 5 to 35 dl/g. The polyethylene resin composition is excellent in at least the following properties (1) to (8): (1) mechanical properties (mechanical properties equal to or higher than those of conventional ultra-high-molecular weight polyethylene), (2) abrasion resistance (abrasion resistance remarkably improved or enhanced as compared with that of conventional ultra-high-molecular weight polyethylene), (3) appearance, (4) moldability, (5) self-lubricating properties, (6) chemical resistance, (7) impact resistance (impact strength), and (8) flexibility.

### FIELD OF THE INVENTION

The present invention relates to a polyethylene resin composition having an excellent balance of properties, such as abrasion resistance, self-lubricating properties, impact strength, chemical resistance, appearance and moldability. More particularly, the invention relates to a polyethylene resin composition having an excellent balance between abrasion resistance, appearance and moldability.

### BACKGROUND OF THE INVENTION

Ultra-high-molecular weight polyethylene has lower intermolecular cohesive force, more symmetric molecular structure and higher crystallinity ,thereby has excellent sliding properties, as compared with general-purpose resins such as ordinary polyethylene, and besides it is excellent in impact strength, abrasion resistance, tensile strength, etc., so that it can be used as, for example, a sliding material.

From the ultra-high-molecular weight polyethylene, however, a molded product is hardly produced because of its high molecular weight, and in many cases, it is difficult to apply the technique commonly used for molding the general-purpose polyethylene to the ultra-high-molecular weight polyethylene.

Further, even if the ultra-high-molecular weight polyethylene is simply blended with polyethylene having a low intrinsic viscosity [η], the abrasion resistance is not improved conspicuously because the ultra-high-molecular weight polyethylene has bad compatibility with the polyethylene having a low intrinsic viscosity [η], and besides, the blend exhibits poor impact strength and appearance (e.g., Japanese Patent Laid-Open Publication No. 240748/1985, Japanese Patent Laid-Open Publication No. 129047/1989, Japanese Patent Laid-Open Publication No. 156344/1989).

Therefore, various proposals have been made in order to impart excellent moldability to the ultra-high-molecular weight polyethylene without impairing the excellent properties of the ultra-high-molecular weight polyethylene.

For example, in Japanese Patent Laid-Open Publication No. 12606/1988, a polyolefin composition for injection molding, which. comprises 15 to 40% by weight of ultra-high-molecular weight polyolefin having an intrinsic viscosity [η] of 10 to 40 dl/g and 85 to 60% by weight of low-molecular weight to high-molecular weight polyolefin having an intrinsic viscosity [η] of 0.1 to 5 dl/g, is disclosed.

This composition is epoch-making for the reasons that the composition can be subjected to injection molding in spite that it contains the ultra-high-molecular weight polyolefin and a molded article obtainable from the composition by injection molding has excellent sliding properties and abrasion resistance inherent in the ultra-high-molecular weight polyolefin.

The above composition, however, has limitations in the flexibility and the abrasion resistance when it is used alone, because the amount of the ultra-high-molecular weight polyolefin is in the range of 15 to 40% by weight.

If the amount of the ultra-high-molecular weight polyolefin is increased within the above range, the abrasion resistance is improved to some extent, but the injection molding becomes difficult, the appearance is bad, and there is room for improvement in the abrasion resistance, moldability and appearance.

It is an object of the present invention to provide a polyethylene resin composition exhibiting at least the following properties (1) to (4) at the same time.

It is another object of the present invention to provide a polyethylene resin composition, in a preferred embodiment, exhibiting the following properties (1) to (8) at the same time:

(1) excellent mechanical properties (mechanical properties equal to or higher than those of conventional ultra-high-molecular weight polyethylene),

(2) excellent abrasion resistance (abrasion resistance remarkably improved or enhanced as compared with that of conventional ultra-high-molecular weight polyethylene),

(3) excellent appearance,

(4) excellent moldability,

(5) excellent self-lubricating properties,

(6) excellent chemical resistance,

(7) excellent impact resistance (impact strength), and

(8) moderate flexibility.

### DISCLOSURE OF THE INVENTION

In view of such problems associated with the prior art as described above, the present inventor has earnestly studied resin compositions having an excellent balance of properties, such as abrasion resistance, self-lubricating properties, appearance and moldability, which are favorably used as covering materials for tubes, hoses and metallic pipes or materials of sliding parts which are injection molded articles. As a result, the present inventor has found that a molded product having remarkably enhanced and well-balanced properties, such as abrasion resistance, self-lubricating properties, appearance, hardness (from flexible to rigid) and molding properties, can be obtained by melt blending a polyethylene resin composition (A) which is obtained by multi-step polymerization and comprises ultra-high-molecular weight polyethylene (component (a-1)) and low-molecular weight to high-molecular weight polyethylene (component (a-2)) in a specific ratio and then molding the resin composition, or by melt blending the resin composition (A) with a polyolefin resin composition (B) having specific properties, such as a flexible composition, a rigid composition, a composition of a wide molecular weight distribution appropriate to covering or a polyethylene resin composition of high flowability appropriate to injection molding, and then molding the resin composition. Based on the finding, the present invention has been accomplished.

That is to say, the polyethylene resin composition according to the present invention is a polyethylene resin composition (A) which comprises ultra-high-molecular weight polyethylene (component (a-1)) having an intrinsic viscosity [η] of 10 to 40 dl/g in an amount of more than 35% by weight and not more than 90% by weight and low-molecular weight to high-molecular weight polyethylene (component (a-2)) having an intrinsic viscosity [η] of 0.1 to 5 dl/g in an amount of not less than 10% by weight and less than 65% by weight, and which has a density of 930 to 980 kg/m³ and an intrinsic viscosity [η] of 5 to 35 dl/g. This polyethylene resin composition (A) is employable as a resin modifier.

The polyethylene resin composition according to the present invention also is a polyethylene resin composition (C) comprising a resin modifier that is the polyethylene resin composition (A) and a polyolefin resin composition (B) containing at least an ethylene (co)polymer having an intrinsic viscosity [η] of 0.1 to 10 dl/g.

The present invention is specified by the following items (1) to (9).

(1) A resin modifier comprising a polyethylene resin composition (A) which comprises ultra-high-molecular weight polyethylene (component (a-1)) having an intrinsic viscosity [η] of 10 to 40 dl/g and low-molecular weight to high-molecular weight polyethylene (component (a-2)) having an intrinsic viscosity [η] of 0.1 to 5 dl/g, wherein:

the amount of the component (a-1) is more than 35% by weight and not more than 90% by weight and the amount of the component (a-2) is not less than 10% by weight and less than 65% by weight, based on the total amount of the component (a-1) and the component (a-2), and

the polyethylene resin composition (A) has a density of 930 to 980 kg/m³ and an intrinsic viscosity [η] of 5 to 35 dl/g.

(2) A polyethylene resin composition (C) comprising 15 to 90% by weight of a polyethylene resin composition (A) and 85 to 10% by weight of a polyolefin resin composition (B), wherein:

the polyethylene resin composition (A) comprises ultra-high-molecular weight polyethylene (component (a-1)) having an intrinsic viscosity [η] of 10 to 40 dl/g and low-molecular weight to high-molecular weight polyethylene (component (a-2)) having an intrinsic viscosity [η] of 0.1 to 5 dl/g,

the amount of the component (a-1) is more than 35% by weight and not more than 90% by weight and the amount of the component (a-2) is not less than 10% by weight and less than 65% by weight, based on the total amount of the component (a-1) and the component (a-2),

the polyethylene resin composition (A) has a density of 930 to 980 kg/m³ and an intrinsic viscosity [η] of 5 to 35 dl/g, and

the polyolefin resin composition (B) contains at least an ethylene (co)polymer having an intrinsic viscosity [η] of 0.1 to 10 dl/g.

(3) The polyethylene resin composition (C) as described in the item (2), wherein the polyolefin resin composition (B) is polyethylene having a density of 820 to 980 kg/m³ and an intrinsic viscosity [η] of 0.1 to 10 dl/g.

(4) The polyethylene resin composition (C) as described in the item (2), wherein the polyolefin resin composition (B) is a resin composition containing polypropylene and an ethylene/α-olefin/diene copolymer.

(5) The polyethylene resin composition (C) as described in the item (2), wherein the polyolefin resin composition (B) contains an ethylene/vinyl alcohol copolymer.

(6) A process for preparing a polyethylene resin composition which comprises ultra-high-molecular weight polyethylene (component (a-1)) having an intrinsic viscosity [η] of 10 to 40 dl/g and low-molecular weight to high-molecular weight polyethylene (component (a-2)) having an intrinsic viscosity [η] of 0.1 to 5 dl/g, the amount of said component (a-1) being more than 35% by weight and not more than 90% by weight, the amount of said component (a-2) being not less than 10% by weight and less than 65% by weight, each amount being based on the total amount of the component (a-1) and the component (a-2), and which has a density of 930 to 980 kg/m³ and an intrinsic viscosity [η] of 5 to 35 dl/g,

comprising multi-step polymerization consisting of at least two steps of:

a first step of polymerizing ethylene in the presence of a Ziegler catalyst to form ultra-high-molecular weight polyethylene having an intrinsic viscosity [η] of 10 to 40 dl/g, and

a second step of polymerizing ethylene in the presence of the ultra-high-molecular weight polyethylene formed in the first step, a Ziegler catalyst and hydrogen to form low-molecular weight to high-molecular weight polyethylene having an intrinsic viscosity [η] of 0.1 to 5 dl/g.

(7) The process for preparing a polyethylene resin composition as described in the item (6), wherein the Ziegler catalyst comprises a high-activity titanium catalyst component containing magnesium, titanium and halogen as essential ingredients and an organoaluminum compound catalyst component.

(8) A covering material or a sliding material made of a resin having a melt flow rate (190° C., load of 10 kg) of not less than 6, a sand abrasion wear, as measured on a sheet having a thickness of 3 mm in a sand abrasion test, of not more than 59 mg, and a limiting PV value, as measured on a sheet having a thickness of 3 mm, of not less than 0.30 (MPa·m/s).

(9) A covering material or a sliding material comprising a resin composition containing at least 2 to 40% by weight of ultra-high-molecular weight polyethylene (component (a-1)) having an intrinsic viscosity [η] of 10 to 40 dl/g, and

having a sand abrasion wear, as measured on a sheet having a thickness of 3 mm in a sand abrasion test, of not more than 59 mg.

### PREFERRED EMBODIMENTS OF THE INVENTION

The resin composition according to the present invention is described in detail hereinafter. The resin composition of the present invention is a polyethylene resin composition (A) comprising a component (a-1) and a component (a-2) or a polyethylene resin composition (C) comprising the polyethylene resin composition (A) and further a polyolefin resin composition (B). First, the polyethylene resin composition (A) for use in the invention, which comprises the component (a-1) and the component (a-2), is described.

### Polyethylene Resin Composition (A)

The polyethylene resin composition (A) for use in the present invention comprises ultra-high-molecular weight polyethylene and low-molecular weight to high-molecular weight polyethylene, and is mainly used as a resin modifier.

In the present invention, the ultra-high-molecular weight polyethylene and the low-molecular weight to high-molecular weight polyethylene for constituting the polyethylene resin composition (A) comprising the component (a-1) and the component (a-2) are each a homopolymer of ethylene or a copolymer of ethylene and an α-olefin, such as propylene, 1-butene, 1-pentene, 1-hexene, 1-octene, 1-decene, 4-methyl-1-pentene or 3-methyl-1-pentene.

Of these, preferably used as the ultra-high-molecular weight polyethylene or the low-molecular weight to high-molecular weight polyethylene is a homopolymer of ethylene or a copolymer of ethylene and the above α-olefin which contains ethylene as a main ingredient.

The ultra-high-molecular weight polyethylene (component (a-1)) for constituting the polyethylene resin composition (A) comprising the component (a-1) and the component (a-2) is polyethylene having an intrinsic viscosity [η], as measured in a decalin solvent at 135° C., of 10 to 40 dl/g, preferably 15 to 35 dl/g, more preferably 20 to 35 dl/g, and can be obtained by polymerization of the first step.

On the other hand, the low-molecular weight to high-molecular weight polyethylene (component (a-2)) is polyethylene having an intrinsic viscosity [η], as measured in a decalin solvent at 135° C. similarly to the above, of 0.1 to 5 dl/g, preferably 0.5 to 3 dl/g, more preferably 1.0 to 2.5 dl/g, and can be obtained by polymerization of the second step after the formation of the ultra-high-molecular weight polyethylene. The polyethylene resin composition (A) comprising the component (a-1) and the component (a-2) can be prepared by polymerizing ethylene in multiple steps in the presence of a catalyst, and the multi-step polymerization can be carried out in the same manner as the polymerization described in Japanese Patent Laid-Open Publication No. 289636/1990.

By the use of the ultra-high-molecular weight polyethylene (component (a-1)) having an intrinsic viscosity [η] of the above range, a molded product having excellent abrasion resistance, self-lubricating properties, impact strength and chemical resistance can be obtained.

In addition to the ultra-high-molecular weight polyethylene (component (a-1)), the low-molecular weight to high-molecular weight polyethylene (component (a-2)) having an intrinsic viscosity [η] of the above range is formed by the post-polymerization, whereby the compatibility with the later-described polyolefin resin composition (B) is enhanced, and as a result, the ultra-high-molecular weight polyethylene is homogeneously dispersed and combined. Hence, a polyethylene resin composition having an excellent balance of properties, such as abrasion resistance, self-lubricating properties, impact strength, chemical resistance, appearance and moldability, particularly an excellent balance between abrasion resistance, appearance and moldability, can be obtained.

In the present invention, the polyethylene resin composition (A) comprising the component (a-1) and the component (a-2) contains the ultra-high-molecular weight polyethylene (component (a-1)) and the low-molecular weight to high-molecular weight polyethylene (component (a-2)) in a specific ratio.

That is to say, the polyethylene resin composition (A) comprising the component (a-1) and the component (a-2) contains the ultra-high-molecular weight polyethylene (component (a-1)) in an amount of more than 35% by weight and not more than 90% by weight, preferably more than 40% by weight and not more than 80% by weight, more preferably 45 to 80% by weight, and contains the low-molecular weight to high-molecular weight polyethylene (component (a-2)) in an amount of not less than 10% by weight and less than 65% by weight, preferably not less than 20% by weight and less than 60% by weight, more preferably 20 to 55% by weight. By setting the ratio between the ultra-high-molecular weight polyethylene (component (a-1)) and the low-molecular weight to high-molecular weight polyethylene (component (a-2)) in the above range, a resin composition containing ultra-high-molecular weight polyethylene of large particles can be obtained, and besides a resin composition can be improved in the compatibility with the polyolefin resin composition (B) and particularly excellent abrasion resistance, appearance and moldability can be obtained.

The polyethylene resin composition (A) comprising the component (a-1) and the component (a-2) substantially consists of the ultra-high-molecular weight polyethylene (component (a-1)) and the low-molecular weight to high-molecular weight polyethylene (component (a-2)).

Accordingly, the sum of the content of the ultra-high-molecular weight polyethylene (component (a-1)) and the content of the low-molecular weight to high-molecular weight polyethylene (component (a-2)) in the polyethylene resin composition (A) comprising the component (a-1) and the component (a-2) is usually 100% by weight. The polyethylene resin composition (A), however, may contain, in addition to the above components, additives which may be added to ordinary polyolefins (such as stabilizer, e.g., heat stabilizer, weathering stabilizer, crosslinking agent, crosslinking assistant, antistatic agent, slip agent, anti-blocking agent, anti-fogging agent, lubricant, dye, pigment, filler, mineral oil type softener, petroleum resin and wax) within limits not detrimental to the objects of the present invention.

The polyethylene resin composition (A) comprising the component (a-1) and the component (a-2), which substantially consists of the ultra-high-molecular weight polyethylene and the low-molecular weight to high-molecular weight polyethylene, has a density, as measured in accordance with ASTM D1505, of 930 to 980 kg/m³, preferably 940 to 980 kg/m³.

The polyethylene resin composition (A) comprising the component (a-1) and the component (a-2.) has an intrinsic viscosity [η], as measured in a decalin solvent at 135° C., of 5 to 35 dl/g, preferably 10 to 30 dl/g, more preferably 12 to 28 dl/g.

Since the polyethylene resin composition (A) comprising the component (a-1) and the component (a-2) has a density of the above range, a molded product of the composition has a low coefficient of dynamic friction and thereby exhibits excellent self-lubricating properties.

Since the polyethylene resin composition (A) comprising the component (a-1) and the component (a-2) has an intrinsic viscosity [η] of the above range, the polyethylene resin composition (A) comprising the component (a-1) and the component (a-2) and the polyolefin resin composition (B) can be well dispersed in each other.

That is to say, the low-molecular weight to high-molecular weight polyethylene contained in the polyethylene resin composition (A) comprising the component (a-1) and the component (a-2) and the polyolefin resin composition (B) are finely dispersed in each other to give a homogeneously dispersed state when they are melt blended by an extruder or the like. Therefore, by the use of the resin composition, a molded product having excellent abrasion resistance, self-lubricating properties, impact strength, chemical resistance, appearance and moldability can be obtained.

The polyethylene resin composition (A) can improve abrasion resistance, self-lubricating properties and the like when it is blended with other resins, so that it can be favorably used as a resin modifier. Although the resin to be modified is not specifically restricted, preferable is a polyolefin resin composition (B).

### Polyolefin Resin Composition (B)

The polyolefin resin composition (B) for use in the present invention is not specifically restricted as far as it is a resin composition containing at least an ethylene (co)polymer having an intrinsic viscosity [η] of 0.1 to 10 dl/g. Examples of the ethylene (co)polymers include high-pressure polyethylene, medium- or low-pressure polyethylene, an ethylene/α-olefin copolymer, an ethylene/vinyl alcohol copolymer, an ethylene/vinyl acetate copolymer, an ethylene/vinyl acetate copolymer saponified product, an ethylene/(meth)acrylic acid copolymer and an ethylene/α-olefin/diene (triene, polyene) terpolymer. Examples of the α-olefins include olefins of 3 to 20 carbon atoms, such as propylene, 1-butene, 1-pentene, 1-hexene, 1-octene, 1-decene, 1-dodecene, 4-methyl-1-pentene and 3-methyl-1-pentene. Examples of the dienes (trienes, polyenes) include conjugated or non-conjugated dienes, trienes and polyenes, such as 5-ethylidene-2-norbornene and vinyl norbornene.

The above ethylene (co)polymers may be used singly, or a resin composition composed of two or more of the ethylene (co)polymers may be used, or a resin composition composed of the ethylene (co)polymer and another polyolefin such as polypropylene or polybutene may be used.

When the polyolefin resin composition (B) is polyethylene, the polyethylene has a density of 820 to 980 kg/m³, preferably 850 to 970 kg/m³, more preferably 860 to 960 kg/m³, and has an intrinsic viscosity [η] of 0.1 to 10 dl/g, preferably 0.2 to 8 dl/g, more preferably 0.3 to 6 dl/g.

As the resin preferably contained in the polyolefin resin composition (B), not only the above-mentioned polyethylene having a density of 820 to 980 kg/m³ and an intrinsic viscosity [η] of 0.1 to 10 dl/g but also a resin composition composed of polypropylene and an ethylene/α-olefin/diene copolymer, or an ethylene/vinyl alcohol copolymer can be mentioned.

Since the polyolefin resin composition (B) for use in the present invention is a resin composition containing at least the ethylene (co)polymer having an intrinsic viscosity [η] of 0.1 to 10 dl/g, the polyolefin resin composition (B) and the polyethylene resin composition (A) comprising the component (a-1) and the component (a-2) can be well dispersed in each other. That is to say, the polyolefin resin composition (B) and the low-molecular weight to high-molecular weight polyethylene contained in the polyethylene resin composition (A) comprising the component (a-1) and the component (a-2) are finely dispersed in each other to give a homogeneously dispersed state when they are melt blended by an extruder or the like. Therefore, by the use of the resin composition, a molded product having excellent abrasion resistance, self-lubricating properties, impact strength, chemical resistance, appearance and moldability can be obtained.

The polyolefin resin composition (B) in the present invention may contain additives which may be added to ordinary polyolefins (such as stabilizer, e.g., heat stabilizer, weathering stabilizer, crosslinking agent, crosslinking assistant, antistatic agent, slip agent, anti-blocking agent, anti-fogging agent, lubricant, dye, pigment, filler, mineral oil type softener, petroleum resin and wax) within limits not detrimental to the objects of the present invention.

### Polyethylene Resin Composition (C)

The polyethylene resin composition (C) according to the present invention comprises the polyethylene resin composition (A) comprising the component (a-1) and the component (a-2) and the polyolefin resin composition (B).

In the polyethylene resin composition (C) comprising the polyethylene resin composition (A) and the polyolefin resin composition (B), the compounding ratio between the polyethylene resin composition (A) and the polyolefin resin composition (B) is as follows: the proportion of the polyethylene resin composition (A) is in the range of 15 to 90% by weight and the proportion of the polyolefin resin composition (B) is in the range of 85 to 10% by weight; preferably, the proportion of the polyethylene resin composition (A) is in the range of 20 to 80% by weight and the proportion of the polyolefin resin composition (B) is in the range of 80 to 20% by weight; more preferably, the proportion of the polyethylene resin composition (A) is in the range of 40 to 60% by weight and the proportion of the polyolefin resin composition (B) is in the range of 60 to 40% by weight.

The amount of the ultra-high-molecular weight polyethylene (component (a-1)) having an intrinsic viscosity [η] of 10 to 40 dl/g contained in the polyethylene resin composition (C) is in the range of 2 to 40% by weight, preferably 5 to 30% by weight, more preferably 10 to 25% by weight.

Since the polyethylene resin composition (C) of the present invention has the above-mentioned compounding ratios, the polyethylene resin composition (A) comprising the component (a-1) and the component (a-2) and the polyolefin resin composition (B) can be well dispersed in each other.

That. is to say, the polyolefin resin composition (B) and the low-molecular weight to high-molecular weight polyethylene contained in the polyethylene resin composition (A) comprising the component (a-1) and the component (a-2) are finely dispersed in each other to give a homogeneously dispersed state when they are melt blended by an extruder or the like.

By the use of the resin composition (C), a molded product having excellent abrasion resistance, self-lubricating properties, impact strength, chemical resistance, appearance, flexibility and moldability can be obtained.

The polyethylene resin composition (C) of the present invention has a melt flow rate (MFR, 190° C., load of 10 kg) of not less than 6, preferably not less than 7, more preferably not less than 8. The sand abrasion wear of a sheet of 3 mm thickness obtained from the polyethylene resin composition (C), as measured in a sand abrasion test, is not more than 59 mg, preferably not more than 55 mg, more preferably not more than 52 mg. The limiting PV value of a sheet of 3 mm thickness obtained from the polyethylene resin composition (C) is not less than 0.30 (MPa·m/s), preferably not less than 0.35, more preferably not less than 0.40.

The sum of the content of the polyethylene resin composition (A) comprising the component (a-1) and the component (a-2) and the content of the polyolefin resin composition (B) in the polyethylene resin composition (C) of the invention is 100% by weight. However, to the composition (C) of the invention may be added other resins within limits not detrimental to the objects of the present invention.

The polyethylene resin composition (C) of the present invention contains, as its essential components, the polyethylene resin composition (A) comprising the component (a-1) and the component (a-2) and the polyolefin resin composition (B), but to the composition (C) may be further added additives, such as filler, stabilizer, e.g., heat stabilizer, weathering stabilizer, crosslinking agent, crosslinking assistant, antistatic agent, slip agent, anti-blocking agent, anti-fogging agent, lubricant, dye, pigment, mineral oil type softener, petroleum resin and wax, within limits not detrimental to the objects of the present invention.

Examples of ultraviolet absorbing agents as the weathering stabilizers arbitrarily added include benzophenone compounds, benzotriazole compounds, nickel compounds and hindered amine compounds. Specific examples of such compounds include 2,2′,4,4′-tetrahydroxybenzophenone, 2-(2′-hydroxy-3′-t-butyl-5′-butylphenyl)-5-chlorobenzotriazole, 2-(2′-hydroxy-3′-t-butyl-5′-butylphenyl)benzotriazole, nickel salt of bis(3,5-di-t-butyl-4-hydroxybenzoyl)phosphoric acid ethyl ester and bis(2,2′,6,6′-tetramethyl-4-piperidine)sebacate.

Examples of the stabilizers arbitrarily added include phenolic antioxidants, such as tetrakis[methylene-3-(3,5-di-t-butyl-4-hydroxyphenyl)propionate]methane, β-(3,5-di-t-butyl-4-hydroxyphenyl)propionic acid alkyl ester and 2,2′-oxamidobis[ethyl-3-(3,5-di-t-butyl-4-hydroxyphenyl)propionate; and fatty acid metallic salts, such as zinc stearate, calcium stearate and calcium 1,2-hydroxystearate.

The above compounds may be used in combination. For example, tetrakis[methylene-3-(3,5-di-t-butyl-4-hydroxyphenyl)propionate]methane and zinc stearate or calcium stearate may be used in combination.

Also employable as the stabilizers are, for example, phosphorus type stabilizers, such as distearyl pentaerythritol diphosphite, di(nonylphenyl)pentaerythritol diphosphite, phenyl-4,4′-isopropylidenediphenol-pentaerythritol diphosphite, bis(2,4-di-t-butylphenyl)pentaerythritol diphosphite, bis(2,6-di-t-butyl-4-methylphenyl)pentaerythritol diphosphite, phenylbisphenol A-pentaerythritol diphosphite, tris(2,4-di-t-butylphenyl)phosphite, tris(nonylphenyl)phosphite, tetrakis(2,4-di-t-butylphenyl)-4,4′-biphenylene diphosphite and bis(2,6-di-t-butyl-4-methylphenyl)pentaerythritol diphosphite.

The above stabilizers can be used singly or in combination of two or more kinds.

The polyethylene resin composition (C) of the present invention may contain organic fillers or inorganic fillers when needed, within limits not detrimental to the objects of the present invention.

For example, silica, diatomaceous earth, alumina, titanium oxide, magnesium oxide, pumice powder, pumice balloon, aluminum hydroxide, magnesium hydroxide, basic magnesium carbonate, dolomite, calcium sulfate, potassium titanate, barium sulfate, calcium sulfite, talc, clay, mica, glass flake, glass bead, Shirasu bead, calcium silicate, montmorillonite, bentonite, graphite, aluminum powder and molybdenum sulfide may be contained.

For preparing the polyethylene resin composition (C) of the present invention, a known process is applicable. For example, a melt blending process comprising preparing the polyethylene resin composition (A) comprising the component (a-1) and the component (a-2) and the polyolefin resin composition (B) separately and melt kneading the polyethylene resin composition (A) and the polyolefin resin composition (B) by an extruder is available.

In this process, kneading is carried out at a temperature at which both of the polyethylene resin composition (A) comprising the component (a-1) and the component (a-2) and the polyolefin resin composition (B) are melted, and the temperature is not specifically restricted. In general, melt kneading is carried out at a temperature of 180 to 400° C. As the extruder, an extruder used for ordinary polyolefin resins is employable, but from the viewpoint of kneading effect, a twin-screw extruder or a tandem extruder is preferable.

### Molded Product

In the present invention, a molded product of desired shape can be obtained by molding the polyethylene resin composition (C) by a known molding method.

For example, by the use of various molding methods, such as injection molding, contour extrusion molding, pipe molding, tube molding, covering for molded product, injection blow molding, direct blow molding, T-die sheet or film molding, inflation molding and press molding, the polyethylene resin composition can be molded into products of various shapes, such as container, tray, sheet, bar and film, or into coverings of various molded products.

Especially when the polyethylene resin composition (C) of the present invention is used to cover resin molded products, it is preferable to use co-extrusion molding.

The molded products obtained as above can be widely applied to the conventionally known polyethylene uses. Because of their particularly excellent balance of properties, such as abrasion resistance, self-lubricating properties, impact strength and thin wall molding properties, the molded products can be applied to uses where such properties are required, for example, covering (lamination) of metallic products, such as steel pipe, electric wire and automobile slide door rail; covering (lamination) of various rubber products, such as pressure-resistant rubber hose, automobile door gasket, clean room door gasket, automobile glass run channel and automobile weather strip; lining of hopper and chute; and sliding materials, such as gear, bearing, roller, tape reel, various guide rails, elevator rail guide and various protective liners.

When the polyethylene resin composition (C) is used as a covering material, the thickness of the covering material is in the range of 10 to 200 μm, preferably 20 to 100 μm. In the use of the polyethylene resin composition (C) as the covering (lamination) material, further, it is preferable that any sea-island structure is not observed on the surface of the resin composition by an electron microscope of 500× magnification, or even if it is observed, the island has an average particle diameter of not more than 20 μm.

In the use of the polyethylene resin composition (C) as the covering (lamination) material, furthermore, the flexural modulus of the polyethylene resin composition (C) is desired to be not more than 1500 MPa, preferably not more than 1300 MPa, more preferably not more than 1000 MPa. In the use of the polyethylene resin composition (C) as the covering (lamination) material, moreover, the tensile elongation at break of the polyethylene resin composition (C) is desired to be not less than 10%, preferably not less than 20%, more preferably not less than 30%.

### EXAMPLES

The present invention is further described with reference to the following examples.

The following examples have a character to aid in the understanding of the present invention and do not give grounds for the limitative interpretation of the present invention.

### Examples 1-3, Comparative Examples 1-4

Ultra-high-molecular weight polyethylene (component (a-1)) having an intrinsic viscosity [η] of 30 dl/g and low-molecular weight polyethylene (component (a-2)) having an intrinsic viscosity [η] of 1.5 dl/g were produced in the weight ratio shown in Table 1 through two-step polymerization and then diluted by blending with, as the polyolefin resin composition (B), high-density low-molecular weight polyethylene (available from Mitsui Chemicals, Inc., trade name: Hizex 1700JP) having an intrinsic viscosity [η] of 1.1 dl/g and a density of 965 kg/m³ in the weight ratio shown in Table 1 so that the concentration of the ultra-high-molecular weight polyethylene (component (a-1)) in the resulting resin composition became 20% by weight. After the blending, the resin composition was melt blended by a PCM twin-screw extruder manufactured by Ikegai Ltd. to prepare pellets.

The resultant blend (pellets) was subjected to injection molding to prepare a test piece (sheet having a thickness of 3 mm), and the test piece was subjected to evaluations, such as a sand abrasion test, a limiting PV value measuring test and visual observation of molded product appearance (dispersed state), in accordance with the test methods described later. The results are set forth in Table 1.

TABLE 1

| | Comp. | Comp. | | | | Comp. | Comp. |
|---|---|---|---|---|---|---|---|
| | Ex. 1 | Ex. 2 | Ex. 1 | Ex. 2 | Ex. 3 | Ex. 3 | Ex. 4 |
| PE resin | 20/80 | 35/65 | 41/59 | 50/50 | 75/25 | 95/5 | 100/0 |
| composition | | | | | | | |
| (A) | | | | | | | |
| Ultra-high- | | | | | | | |
| molecular | | | | | | | |
| weight PE/PE | | | | | | | |
| (weight ratio) | | | | | | | |
| PE resin | 100/0 | 57.1/42.9 | 49/51 | 40/60 | 26.7/73.3 | 21.1/78.9 | 20/80 |
| Composition | | | | | | | |
| (A)/PO resin | | | | | | | |
| composition | | | | | | | |
| (B) (weight | | | | | | | |
| ratio) | | | | | | | |
| Proportion of | 20 | 20 | 20 | 20 | 20 | 20 | 20 |
| ultra-high- | | | | | | | |
| molecular | | | | | | | |
| weight PE | | | | | | | |
| after melt | | | | | | | |
| blending (wt %) | | | | | | | |
| Sand abrasion | 64 | 62 | 51 | 50 | 47 | 60 | 65 |
| wear (mg) | | | | | | | |
| Limiting PV | 0.49 | 0.49 | 0.49 | 0.49 | 0.49 | 0.49 | 0.49 |
| value | | | | | | | |
| (MPa · m/s) | | | | | | | |
| MFR (g/10 min) | 6 | 10 | 8 | 7 | 14 | 16 | 32 |
| Abrasion | BB | BB | AA | AA | AA | BB | BB |
| resistance | | | | | | | |
| Self- | AA | AA | AA | AA | AA | AA | AA |
| lubricating | | | | | | | |
| properties | | | | | | | |
| Injection | AA | AA | AA | AA | AA | AA | AA |
| moldability | | | | | | | |
| Molded product | AA | AA | AA | AA | AA | BB | BB |
| appearance | | | | | | | |
| (dispersed | | | | | | | |
| state) | | | | | | | |

### Examples 4-6, Comparative Examples 5-8

Ultra-high-molecular weight polyethylene (component (a-1)) having an intrinsic viscosity [η] of 30 dl/g and low-molecular weight polyethylene (component (a-2)) having an intrinsic viscosity [η] of 1.5 dl/g were produced in the weight ratio shown in Table 2 through two-step polymerization and then diluted by blending with, as the polyolefin resin composition (B), high-molecular weight polyethylene (available from Mitsui Chemicals, Inc., trade name: Hizex 5100E) having an intrinsic viscosity [η] of 2.6 dl/g and a density of 944 kg/m³ in the weight ratio shown in Table 2 so that the concentration of the ultra-high-molecular weight polyethylene (component (a-1)) in the resulting resin composition became 20% by weight. After the blending, the resin composition was melt blended by a PCM twin-screw extruder manufactured by Ikegai Ltd. to prepare pellets.

The resultant blend (pellets) was subjected to injection molding to prepare a test piece (sheet having a thickness of 3 mm), and the test piece was subjected to a sand abrasion test and a limiting PV value measuring test in accordance with the test methods described later. Further, measurements of a flexural modulus and a tensile elongation at break of the test piece were carried out.

By the use of an inflation film molding machine, molding of the blend into a tube having a thickness of 100 to 200 μm was attempted, and the moldability into tube and the tube appearance (dispersed state of ultra-high-molecular weight polyethylene) were evaluated. The results are set forth in Table 2.

TABLE 2

| | Comp. | Comp. | | | | Comp. | Comp. |
|---|---|---|---|---|---|---|---|
| | Ex. 5 | Ex. 6 | Ex. 4 | Ex. 5 | Ex. 6 | Ex. 7 | Ex. 8 |
| PE resin | 20/80 | 35/65 | 41/59 | 50/50 | 75/25 | 95/5 | 100/0 |
| composition | | | | | | | |
| (A) | | | | | | | |
| Ultra-high- | | | | | | | |
| molecular | | | | | | | |
| weight PE/PE | | | | | | | |
| (weight | | | | | | | |
| ratio) | | | | | | | |
| PE resin | 100/0 | 57.1/42.9 | 49/51 | 40/60 | 26.7/73.3 | 21.1/78.9 | 20/80 |
| composition | | | | | | | |
| (A)/PO resin | | | | | | | |
| composition | | | | | | | |
| (B) (weight | | | | | | | |
| ratio) | | | | | | | |
| Proportion of | 20 | 20 | 20 | 20 | 20 | 20 | 20 |
| ultra-high- | | | | | | | |
| molecular | | | | | | | |
| weight PE | | | | | | | |
| after melt | | | | | | | |
| blending | | | | | | | |
| (wt %) | | | | | | | |
| Sand abrasion | 64 | 62 | 40 | 38 | 36 | 50 | 60 |
| wear (mg) | | | | | | | |
| Limiting PV | 0.49 | 0.39 | 0.35 | 0.32 | 0.30 | 0.20 | 0.19 |
| value | | | | | | | |
| (MPa · m/s) | | | | | | | |
| Moldability | Infea- | Fea- | Fea- | Fea- | Fea- | Fea- | Infea- |
| into tube | sible | sible | sible | sible | sible | sible | sible |
| Abrasion | BB | BB | AA | AA | AA | AA | BB |
| resistance | | | | | | | |
| Self- | AA | AA | AA | AA | AA | BB | BB |
| lubricating | | | | | | | |
| properties | | | | | | | |
| Moldability | BB | AA | AA | AA | AA | BB | BB |
| Molded | — | AA | AA | AA | AA | BB | — |
| product | | | | | | | |
| appearance | | | | | | | |
| (dispersed | | | | | | | |
| state) | | | | | | | |
| Flexural | 1630 | 1300 | 1200 | 1000 | 800 | 750 | 500 |
| modulus (MPa) | | | | | | | |
| Tensile | 8 | 50 | 180 | 250 | 100 | 5 | 3 |
| elongation at | | | | | | | |
| break (%) | | | | | | | |

### Examples 7-10, Reference Examples 1-4

Linear polyethylene produced by two-step polymerization and containing ultra-high-molecular weight polyethylene (component (a-1)) having an intrinsic viscosity [η] of 30 dl/g and low-molecular weight polyethylene (component (a-2)) having an intrinsic viscosity [η] of 1.5 dl/g in the weight ratio shown in Table 1 was diluted by blending with, as the polyolefin resin composition (B), high-density low-molecular weight polyethylene (available from Mitsui Chemicals, Inc., trade name: Hizex 1700JP) having an intrinsic viscosity [η] of 1.1 dl/g and a density of 965 kg/m³ in the weight ratio shown in Table 3. After the blending, the resin composition was melt blended by a PCM twin-screw extruder manufactured by Ikegai Ltd. to prepare pellets.

The resultant blend (pellets) was subjected to injection molding to prepare a test piece (sheet having a thickness of 3 mm), and the test piece was subjected to evaluations, such as a sand abrasion test, a limiting PV value measuring test and visual observation of molded product appearance (dispersed state), in accordance with the test methods described later. The results are set forth in Table 3.

TABLE 3

| | Ref. | | | Ref. | Ref. | | | Ref. |
|---|---|---|---|---|---|---|---|---|
| | Ex. 1 | Ex. 7 | Ex. 8 | Ex. 2 | Ex. 3 | Ex. 9 | Ex. 10 | Ex. 4 |
| PE resin | 45/55 | 45/55 | 45/55 | 45/55 | 80/20 | 80/20 | 80/20 | 80/20 |
| composition | | | | | | | | |
| (A) | | | | | | | | |
| Ultra-high- | | | | | | | | |
| molecular | | | | | | | | |
| weight PE/ | | | | | | | | |
| PE (weight | | | | | | | | |
| ratio) | | | | | | | | |
| PE resin | 8/92 | 20/80 | 85/15 | 95/5 | 8/92 | 20/80 | 85/15 | 92/8 |
| composition | | | | | | | | |
| (A)/PO resin | | | | | | | | |
| composition | | | | | | | | |
| (B) (weight | | | | | | | | |
| ratio) | | | | | | | | |
| Proportion of | 3.6 | 9 | 38.3 | 42.8 | 6.4 | 12 | 68 | 73.6 |
| ultra-high- | | | | | | | | |
| molecular | | | | | | | | |
| weight PE | | | | | | | | |
| after melt | | | | | | | | |
| blending | | | | | | | | |
| (wt%) | | | | | | | | |
| Sand | 68 | 55 | 42 | 33 | 65 | 53 | 27 | 18 |
| abrasion | | | | | | | | |
| wear (mg) | | | | | | | | |
| Limiting PV | 0.49 | 0.49 | 0.49 | 0.49 | 0.49 | 0.49 | 0.49 | 0.49 |
| value | | | | | | | | |
| (MPa · m/s) | | | | | | | | |
| MFR (g/- | 20 | 15 | 7 | 1.7 | 18 | 10 | 6 | 0.8 |
| 10 min) | | | | | | | | |
| Abrasion | BB | AA | AA | AA | BB | AA | AA | AA |
| resistance | | | | | | | | |
| Self- | AA | AA | AA | AA | AA | AA | AA | AA |
| lubricating | | | | | | | | |
| properties | | | | | | | | |
| Injection | AA | AA | AA | BB | AA | AA | AA | BB |
| moldability | | | | | | | | |
| Molded | BB | AA | AA | BB | BB | AA | AA | PB |
| product | | | | | | | | |
| appearance | | | | | | | | |
| (dispersed | | | | | | | | |
| state) | | | | | | | | |

Test methods

Sand abrasion test

In a stirring vessel, a mixture liquid of 3 kg of water and 2.6 kg of abrasive grains (JIS R6001 (A-43)) was placed, and 4 plates (test pieces) having a width of 25 mm, a length of 75 mm and a thickness of 3 mm were set on the stirring blade in such a manner that the angle between the plate and the mixture liquid was 45° . Then, the stirring blade was rotated at a rate of 1600 rpm for 3 hours to measure a sand abrasion wear. In a jacket of the stirring vessel, cooling water of 25° C. was circulated.

The abrasion resistance was evaluated as follows. From the weight of the test piece before the test, the weight of the test piece after the test was subtracted to obtain an abrasion wear (mg) of the sample. A test piece having a sand abrasion wear of not more than 59 mg was evaluated as AA (pass). (Sand abrasion wear of conventional one (Comparative Example 1): not less than 60 mg) (See Table 1, Table 2 and Table 3)

Limiting PV Value

The self-lubricating properties were evaluated as follows. By the use of a metal plate (SUS-304) as a counter material, the test piece was abraded by a friction-abrasion tester (manufactured by KK Orientech, EFM-H1-ENS) with maintaining the peripheral velocity (V) constant at 0.2 m/s and increasing a load (P) every 30 minutes by 5 kg·f, and a load at which the test piece began to melt by frictional heat was measured to find a limiting PV value (MPa·m/s). A test piece having a limiting PV value of not less than 0.3 was evaluated as AA (pass). (Limiting PV value of ultra-high-molecular weight polyethylene conventionally used: not less than 0.28) (See Table 1, Table 2 and Table 3)

MFR (Melt Flow Rate)

As a measure of flowability, MFR was measured. A test piece having MFR of not lower than the MFR value (6 g/10 min) of a conventional one (Comparative Example 1) was evaluated as AA (pass) (see Table 1).

Measuring temperature: 190° C.

Load: 10 kg

Flexural Modulus

The flexural modulus was measured in accordance with ASTM D790.

Tensile Elongation at Break

The tensile elongation at break was measured in accordance with ASTM D638.

### INDUSTRIAL APPLICABILITY

Since the polyethylene resin composition according to the present invention comprises a polyethylene resin composition (A) comprising an ultra-high-molecular weight polyethylene component and a low-molecular weight to high-molecular weight polyethylene component or comprises the polyethylene resin composition (A) and a specific polyolefin resin composition (B), it has not only excellent abrasion resistance and mechanical properties inherent in the ultra-high-molecular weight polyethylene but also specific properties of the low-molecular weight to high-molecular weight polyethylene and/or the polyolefin resin composition (B). Hence, a molded product having an excellent balance of properties, such as abrasion resistance, self-lubricating properties, impact strength, chemical resistance, appearance, flexibility and molding properties, particularly an excellent balance between abrasion resistance, appearance and molding properties, can be obtained.

Because of its excellent abrasion resistance, self-lubricating properties, appearance, flexibility and moldability, the polyethylene resin composition of the present invention can be favorably used as a material of an injection molded product, a covering (lamination) material for various molded products such as steel pipe, pressure-resistant rubber hose, electric wire and sheet, or a sliding material.

An effect of the present invention is that a polyethylene resin composition exhibiting at least the following properties (1) to (4) at the same time can be provided.

Another effect of the present invention is that a polyethylene resin composition, in a preferred embodiment, exhibiting the following properties (1) to (8) at the same time can be provided:

(1) excellent mechanical properties (mechanical properties equal to or higher than those of conventional ultra-high-molecular weight polyethylene),

(2) excellent abrasion resistance (abrasion resistance remarkably improved or enhanced as compared with that of conventional ultra-high-molecular weight polyethylene),

(3) excellent appearance,

(4) excellent moldability,

(5) excellent self-lubricating properties,

(6) excellent chemical resistance,

(7) excellent impact resistance (impact strength), and

(8) moderate flexibility.

What is claimed is:

1. A resin modifier comprising a polyethylene resin composition (A) which comprises ultra-high-molecular weight polyethylene (component (a-1)) having an intrinsic viscosity [η] of 10 to 40 dl/g and low-molecular weight to high-molecular weight polyethylene (component (a-2)) having an intrinsic viscosity [η] of 0.1 to 5 dl/g, wherein:
the amount of the component (a-1) is more than 35% by weight and not more than 90% by weight and the amount of the component (a-2) is not less than 10% by weight and less than 65% by weight, based on the total amount of the component (a-1) and the component (a-2), and
the polyethylene resin composition (A) has a density of 930 to 980 kg/m³ and an intrinsic viscosity [η] of 5 to 35 dl/g.

2. A polyethylene resin composition (C) comprising 15 to 90% by weight of a polyethylene resin composition (A) and 85 to 10% by weight of a polyolefin resin composition (B), wherein:
the polyethylene resin composition (A) comprises ultra-high-molecular weight polyethylene (component (a-1)) having an intrinsic viscosity [η] of 10 to 40 dl/g and low-molecular weight to high-molecular weight polyethylene (component (a-2)) having an intrinsic viscosity [η] of 0.1 to 5 dl/g,
the amount of the component (a-1) is more than 35% by weight and not more than 90% by weight and the amount of the component (a-2) is not less than 10% by weight and less than 65% by weight, based on the total amount of the component (a-1) and the component (a-2),
the polyethylene resin composition (A) has a density of 930 to 980 kg/m³ and an intrinsic viscosity [η] of 5 to 35 dl/g, and
the polyolefin resin composition (B) contains at least an ethylene (co)polymer having an intrinsic viscosity [η] of 0.1 to 10 dl/g.

3. The polyethylene resin composition (C) as claimed in claim 2, wherein the polyolefin resin composition (B) is polyethylene having a density of 820 to 980 kg/m³ and an intrinsic viscosity [η] of 0.1 to 10 dl/g.

4. The polyethylene resin composition (C) as claimed in claim 2, wherein the polyolefin resin composition (B) is a resin composition containing polypropylene and an ethylene/α-olefin/diene copolymer.

5. The polyethylene resin composition (C) as claimed in claim 2, wherein the polyolefin resin composition (B) contains an ethylene/vinyl alcohol copolymer.

6. A process for preparing a polyethylene resin composition which comprises ultra-high-molecular weight polyethylene (component (a-1)) having an intrinsic viscosity [η] of 10 to 40 dl/g and low-molecular weight to high-molecular weight polyethylene (component (a-2)) having an intrinsic viscosity [η] of 0.1 to 5 dl/g, the amount of said component (a-1) being more than 35% by weight and not more than 90% by weight, the amount of said component (a-2) being not less than 10% by weight and less than 65% by weight, each amount being based on the total amount of the component (a-1) and the component (a-2), and which has a density of 930 to 980 kg/m³ and an intrinsic viscosity [η] of 5 to 35 dl/g,
comprising multi-step polymerization consisting of at least two steps of:
a first step of polymerizing ethylene in the presence of a Ziegler catalyst to form ultra-high-molecular weight polyethylene having an intrinsic viscosity [η] of 10 to 40 dl/g, and
a second step of polymerizing ethylene in the presence of the ultra-high-molecular weight polyethylene formed in the first step, a Ziegler catalyst and hydrogen to form low-molecular weight to high-molecular weight polyethylene having an intrinsic viscosity [η] of 0.1 to 5 dl/g.

7. The process for preparing a polyethylene resin composition as claimed in claim 6, wherein the Ziegler catalyst comprises a high-activity titanium catalyst component containing magnesium, titanium and halogen as essential ingredients and an organoaluminum compound catalyst component.

8. A covering material or a sliding material made of a resin having a melt flow rate (190° C., load of 10 kg) of not less than 6, a sand abrasion wear, as measured on a sheet having a thickness of 3 mm in a sand abrasion test, of not more than 59 mg, and a limiting PV value, as measured on a sheet having a thickness of 3 mm, of not less than 0.30 (MPa·m/s).

9. A covering material or a sliding material comprising a resin composition containing at least 2 to 40% by weight of ultra-high-molecular weight polyethylene (component (a-1)) having an intrinsic viscosity [η] of 10 to 40 dl/g, and
having a sand abrasion wear, as measured on a sheet having a thickness of 3 mm in a sand abrasion test, of not more than 59 mg.
